(19) United States
(12) Patent Application Publication
(10) Pub. No.: US 2011/0095536 A1
(43) Pub. Date: Apr. 28, 2011

(54) Fluid Responsive Energy Generator

(76) Inventor: Randolph E. Bridwell, Sarasota, FL (US)

(21) Appl. No.: 12/605,097

(22) Filed: Oct. 23, 2009

(51) Int. Cl. F03D 9/00; F03D 11/00

(52) U.S. Cl. 290/54; 290/55

(57) ABSTRACT

A power plant with one or more fluid operated fans, each of which is in communication with a generator, is provided to generate energy. Each generator is in communication with an energy storage device or a power grid to store or utilize energy, respectively. A rotatable arm attached to a support is provided. A tether between a fan and the rotatable arm is provided. As the fan is exposed to a fluid flow, the fluid flow causes blades of the fan to rotate. The fan communicates a rotational movement to a shaft of corresponding generator via a system of gears and a driving belt providing a required drive ratio.

### FIELD OF THE INVENTION

The present invention relates to an apparatus and method for generating energy. More specifically, the present invention generates energy from a fluid source and harvests the energy as a power source.

### BACKGROUND

Fossil fuels are comprised of a finite quantity of hydrocarbons and are employed as an energy source. The economic principle of supply and demand suggests that as hydrocarbon supplies diminish, costs for such supply will rise. In addition, combustion of fossil fuels is known to result in the increased emission of carbon dioxide into the atmosphere. Accordingly, based upon the laws of economics and a need to reduce pollution, there is an incentive to seek alternative clean energy.

One known clean energy solution is wind energy that leverages the natural wind currents to create electrical energy. For example, on the coastline near Cape Cod, Mass., there is a wind energy farm planned to include a large array of windmills to utilize the natural wind currents in the ocean and to convert the wind currents into electrical energy. It is projected that completion of the wind farm could supply about three quarters of the required electrical energy to Cape Cod. This geographical region is being targeted for installation of the wind farm due to the natural wind currents present in the region. However, there are opponents to the construction of the wind farm in this location as it is adjacent to a vacation resort frequented by a predominately wealthy clientele who do not want a view of the wind farm from their residence. Accordingly, there is a need for technology that utilizes fluid flow to produce clean electrical energy that can be supplied to residential and commercial consumers, but is not restricted to a geographical location based upon natural wind currents.

### SUMMARY OF THE INVENTION

In one aspect of the invention, an apparatus is provided to harvest fluid flow. The apparatus is configured with a support member having a proximal end and a distal end, and a first rotatable element attached to the distal end of the support member. The first rotatable element is configured to rotate about the axis of the support member. A tether system is provided in communication with the first rotatable element. More specifically, the tether system is provided with a proximal end and a distal end, with the distal end in communication with the first rotatable element and the proximal end in communication with an energy generating unit. The energy generating unit is configured with a second rotatable element having at least one blade, with the blade in communication with a first shaft. In addition, the energy generating unit is configured with a generator in communication with a second shaft. More specifically, upon exposure of the blade to a fluid flow, the first shaft is rotated and this rotation is communicated to the second shaft of the generator. The rotation of the second shaft results in the generator generating energy.

In another aspect of the invention, an apparatus is provided with a support member in communication with a first rotatable element. The support member has both a proximal end and a distal end, with the first rotatable element attached to the distal end. The first rotatable element is configured to rotate about the axis of the support member. A tether system is provided in communication with the first rotatable element. More specifically, the tether system includes at least one tether in communication with a secondary support element. A distal end of the tether is attached to the first rotatable element, and a proximal end of the tether is attached to the secondary support element. In addition, a generating unit is provided in communication with the secondary support element. The generating unit is configured with a second rotatable element having at least two blades and a generator. As the blades of the second rotatable element are exposed to a fluid flow, the blades rotate about a shaft, and this rotational movement is communicated to a shaft of the generator to generate energy.

Other features and advantages of this invention will become apparent from the following detailed description of the presently preferred embodiments of the invention taken in conjunction with the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention unless otherwise explicitly indicated. Implications to the contrary are otherwise not to be made.

FIG. 1 is an elevational view of one embodiment of a power plant.

FIG. 2a is an elevational view of a tether system in communication with a fan.

FIG. 2b is a perspective view of a tether system in communication with a fan.

FIG. 3 is an elevational view of second embodiment of a power plant.

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, such as examples of modules, managers, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

### Overview

The present invention relates to an apparatus and method for generating electricity based upon fluid flow. A power plant is provided that generates electrical energy from mechanical energy associated with a fluid flow. The power plant is configured with one or more generating units, each of which includes a rotatable element in communication with a fluid flow responsive generator. In one embodiment, the rotatable element is a fan blade in communication with an associated shaft. As the fan blade is subject to fluid flow, the fan rotates about its axis and causes rotation of the associated shaft. The fan blade is in communication with a shaft. As the blade rotates, the shaft associated with the blade rotates and communicates the rotation to a shaft of the generator, which generates energy responsive to the rotation. Accordingly, the generator creates energy responsive to fluid flow.

### Technical Details

In the following description of the embodiments, reference is made to the accompanying drawings that form a part hereof, and which shows by way of illustration the specific embodiment in which the invention may be practiced. It is to be understood that other embodiments may be utilized because structural changes may be made without departing from the scope of the present invention.

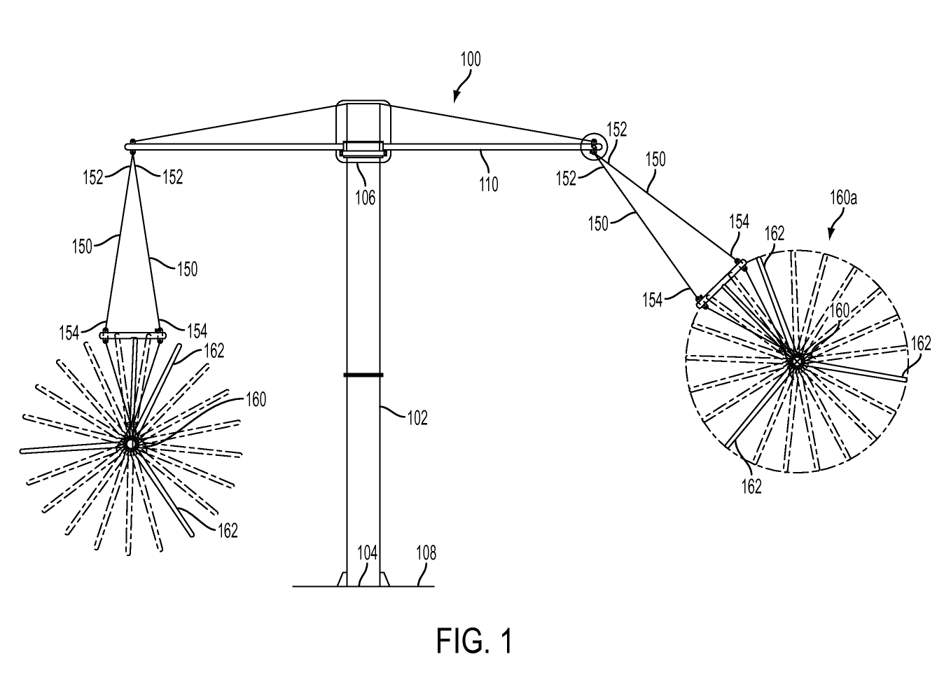

FIG. 1 is an elevational view of one embodiment of a power plant (100) with one or more fluid responsive rotatable elements in communication with a generator. As shown, the power plant (100) includes a central vertical member (102) in communication with a rotatable arm (110). The vertical member (102) includes a proximal end (104) and a distal end (106). The proximal end (104) of the vertical member (102) is stationary and fixed to a planar platform (108). The distal end (106) of the vertical member (102) is remote from the proximal end (104) and is in communication with the rotatable arm (110). In one embodiment, the rotatable arm may be in the form of a rotatable element that is either rigid or flexible. Similarly, in one embodiment, the vertical member (102) may be replaced with an alternative support member that enables the functionality of the generating unit(s) (160). Accordingly, the scope of the invention should not be limited to a rotatable arm (110) with a rigid characteristic nor the vertical alignment of the support member (102).

The rotatable arm (110) is configured to rotate about the axis of the vertical member (102). A rotational device (not shown) causes rotation of the rotatable arm (110). In one embodiment, the rotational device can be in form of a motor. As shown, one or more tethers (150) are configured in communication with the rotatable arm (110). The tether (150) is provided with a proximal end (152) in communication with the rotatable arm (110), and a distal end (154) in communication with an energy generating unit (160). For ease of description, each tether (150) and associated energy generating unit (160) is referenced with a like number. The tether (150) is a connection element between the rotatable arm (110) and the energy generating unit (160). The tether (150) may employ various materials with sufficient strength to support the connection. In one embodiment, the tether (150) is comprised of a material that enables the connection element to flex.

Each generating unit (160) includes at least one fan blade (162) and a generator (not shown) in communication with the fan blade (162). In one embodiment, rotation of the rotatable arm (110) creates a fluid flow that is communicated to the fan blade (162). In yet another embodiment, the fan blade (162) rotates when subject to fluid flow provided by wind power.

As shown in FIG. 1, one of the generator units (160) is in a lifted position (160a), with the components, including the blade (162). The flex and length characteristic of the associated tether(s) (150) supports the lifted position (160a). The lifted position (160a) should not be limited to the position shown herein. In one embodiment, the lifted position (160a) may be shown at a different position with respect to the central vertical member (102).

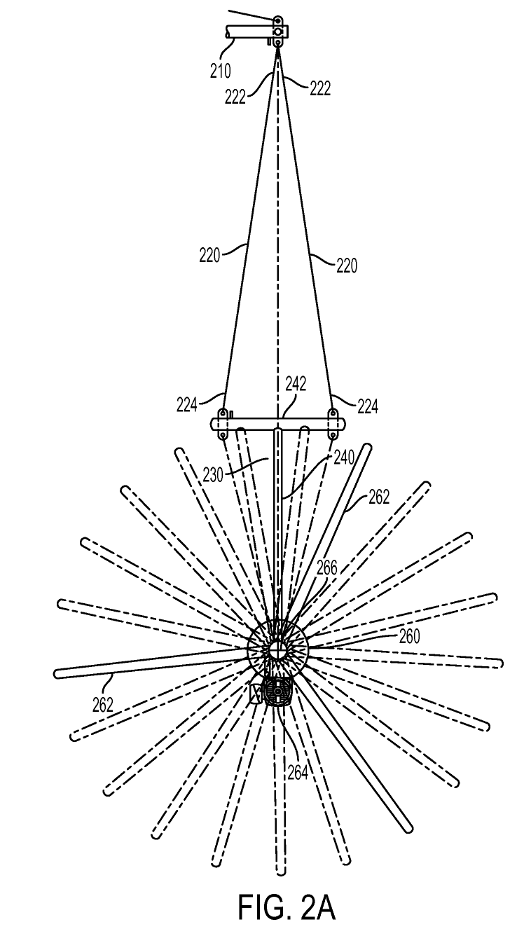

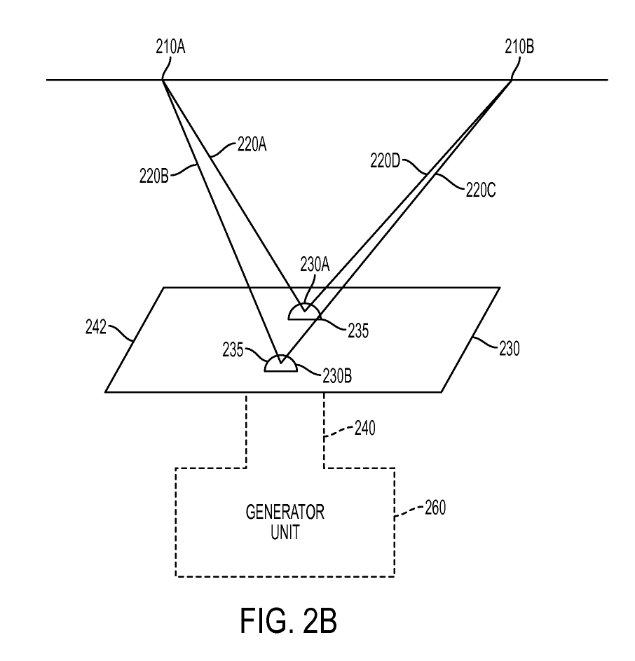

As shown in FIGS. 2A and 2B, the fan blade (262) has an associated shaft (266) which is in communication with a shaft (not shown) of the generator (264). Rotational movement of the fan blade (262) is communicated to the shaft (266) and from the shaft (266) to a shaft of the corresponding generator (264). In one embodiment, the communication of rotation between the shafts can be in the form of a gear box, a drive belt, a system of pulleys, a direct drive system, gears, or a hydraulic system. Similarly, in one embodiment a required drive ratio may be configured based upon the form of communication between the shafts. The generator unit (260) is configured to generate energy based upon rotation of its shaft.

Furthermore, as shown in FIGS. 2A and 2B, each of the generating units (260) may be supported by one or more tethers. In one embodiment, the plurality of tethers may be employed to support the weight of the generating unit (260). Similarly, in one embodiment, the plurality of tethers may be employed and configured to maintain a separation between adjacent generating units. More specifically, each of tethers (220) is configured with a proximal end (222) and a distal end (224). The proximal end (222) of each tether (220) is in communication with a rotatable arm (210), and the distal end of each tether (220) is in communication with the generating unit (260). As shown in FIG. 2B, two adjacent elements (210a) and (210b) of the rotatable arm (210) are configured to support a single generating unit (260). In one embodiment, the two adjacent elements (210a) and (210b) of the rotatable arm (210) may be configured to support multiple generating units (260). Similarly, in one embodiment, the generating unit (260) is in communication with a secondary support element (230) which functions as a communication platform between the tethers (220) and the generating unit (260). As shown, element (210a) is configured with two tethers (220a) and (220b) that extend from element (210a) to opposite ends of the secondary support element (230). More specifically, tether (220a) extends from element (210a) to a first end (230a) of the secondary support element (230) and tether (220b) extends from element (210a) to a second end (230b) of the secondary support element (230). Similarly, tether (220c) extends from element (210b) to the second end (230b) of the secondary support element (230) and tether (220d) extends from element (210b) to the first end (230a) of the secondary support element. In one embodiment, the end of the tether that communicates with the secondary support element (230) is secured to the secondary support element (230) with an attachment element. Similarly, in one embodiment, the multiple tethers may be secured to an attachment element (235) in communication with secondary support element (230), wherein multiple tethers may share the same attachment element or multiple tethers may employ separate attachment elements, which may be spaced separately across a surface of the secondary support element (230). Examples of attachment element include, but are not limited to pin shackles. In one embodiment, the secondary support element is in form of a connector having a vertical section (240) and a planar section (242) with the tethers secured to the planar section (242) and the vertical section (242) in communication with a corresponding generating unit (260).

The configuration of the tethers extending from the rotatable arm (210) to the generating unit (260) is configured to provide stability and flexibility to the system and prevent adjacent generating units (260) from crossing paths. In one embodiment, the tethers include an energy transfer device to support communication of electrical energy produced by generators to an electrical storage device and/or power grid. In one embodiment, the energy transfer device may be in form of an electrical cable. In this case, the tethers may be provided with an attached electrical cable to follow the path of the tether from the rotatable arm (210) to the generating unit (260). The electrical cable functions to transmit electrical energy converted from fluid flow to an electrical storage device and/or a power grid. In an embodiment wherein the generator generates non-electrical energy, the energy transfer device may be in the form of a cable, an air hose, a hydraulic hose, steam, etc. Each of these alternative energy transfer devices may be employed to support different forms of energy generating units, including but not limited to an air pump, water pump, hydraulic pump, etc. With respect to the tether, in one embodiment, the length of the tether(s) and/or the angle between adjacently mounted tethers is adjustable, including both static and/or dynamic adjustment.

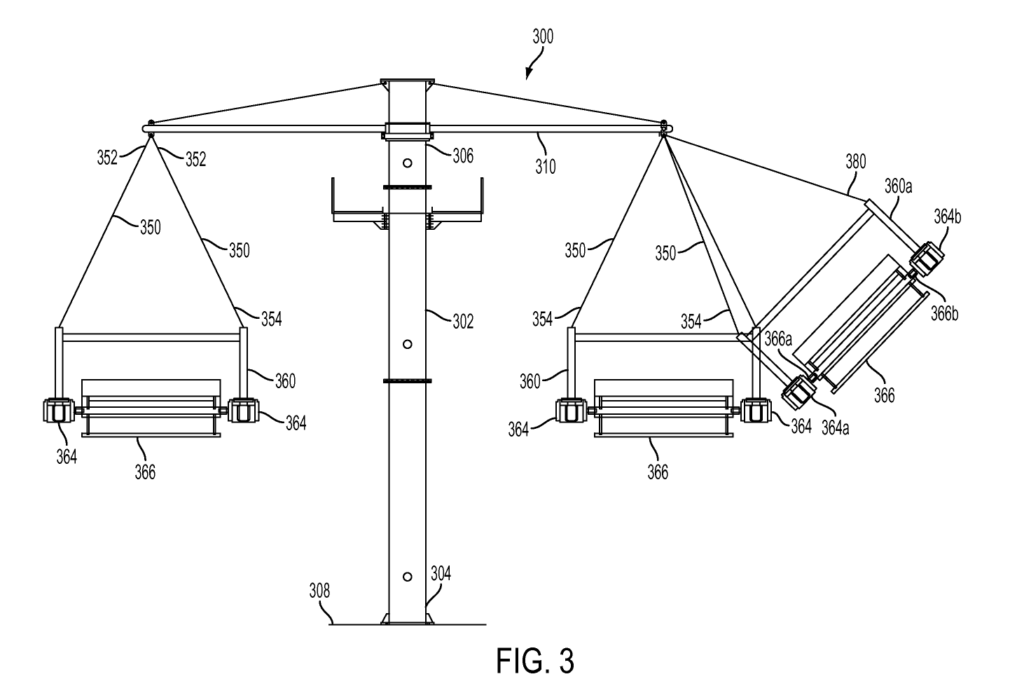

FIG. 3 is an elevational view of the second embodiment of a power plant (300) with one or more fluid responsive rotatable elements in communication with a generator. As shown, the power plant (300) includes a central vertical member (302) in communication with a rotatable arm (310). The vertical member (302) includes a proximal end (304) and a distal end (306). The proximal end (304) of the vertical member (102) is stationary and fixed to a planar platform (108). The distal end (306) of the vertical member (302) is remote from the proximal end (304) and is in communication with the rotatable arm (310). In one embodiment, the rotatable arm may be in the form of a rotatable element that is either rigid or flexible.

The rotatable arm (310) is configured to rotate about the axis of the vertical member (302). A rotational device (not shown) causes rotation of the rotatable arm (310). In one embodiment, the rotational device can be in the form of a motor. As shown, one or more tethers (350) are configured in communication with the rotatable arm (310). The tether (350) is provided with a proximal end (352) in communication with the rotatable arm (310), and a distal end (354) in communication with an energy generating unit (160). For ease of description, each tether (350) and associated energy generating unit (360) is referenced with a like number. The tether (350) is a connection element between the rotatable arm (310) and the energy generating unit (360). The tether (350) may employ various materials with sufficient strength to support the connection. In one embodiment, the tether (350) is comprised of a material that enables the connection element to flex. Each generating unit (360) includes a generator (364) provided with at least one blade (366). As shown herein, each generating unit (360) includes at least one fan blade (366) in communication with at least one generator (364). In one embodiment, the fan blade (366) has two ends, with each end in communication with a separate generator or multiple generators. For example, as shown in the lift position (380), a first end (366a) of the fan blade (366) may be in communication with a first generator (364a) and a second end (366b) may be in communication with a second generator (364b). In one embodiment, each generating unit is supported by two tethers attached at two different sides of the generating unit. A fluid flow communicated to the generator blades causes a rotation of a generator shaft (not shown) in communication with the blades, which results in energy generation.

An individual generator unit (360) may be subject to a lift responsive to the fluid flow. As shown in FIG. 3, one of the generator units (360) is in a lifted position (360a), with the components, including the blade (366a) together with the generators (364a). The flex and length characteristic of the associated tether(s) supports the lifted position (360a). The lifted position (360a) should not be limited to the position shown herein. In one embodiment, the lifted position (360a) may be shown at a different position with respect to the central vertical member (302).

As shown herein, the fan blade (162), (262), or (366) may be in communication with a single energy generating unit, or in communication with multiple energy generating unit. By employing multiple energy generating units with each fan blade or set of fan blade, energy may be harvested from multiple generators with the same fluid flow. In other words, multiple energy generating units may be employed to respond to the same fluid flow. In one embodiment, the multiple energy generating units function independent of each other, with each generating unit responding the fluid flow of the fan blade or set of fan blades. Similarly, by positioning the blades and associated generating units in a circumferential manner, fluid flow may be harvested from multiple positions with different positions being subject to the same or different force from the fluid flow. Accordingly, the position and configuration of the blade(s) and associated generating unit(s) provide efficiency for energy generation.

It will be understood that each of the elements above, may also be useful in alternative applications or constructions differing from the type described above and without departing from the spirit and scope of the invention. In particular, in one embodiment, the generator may be configured to generate direct current electricity. However, the generating unit configured to generate electrical energy should not be limited to direct current. In one embodiment, the generator may be in the form of an alternator that generates alternating current electricity. The term “generator” described herein is interchangeable with a direct current or alternating current unit. Similarly, in one embodiment, a single material may be employed to serve the functionality of both the connection element and the wire. This simplifies the structure of the power plant by eliminating an extraneous filament between the generator unit and the wire transfer system. In one embodiment, a wireless energy communication system may be employed to convey energy from the generator and/or generating unit to an energy storage device or a storage grid. The generated electrical energy may be stored in the associated battery or any other electrical storage device, including but not limited to a capacitor or any other device with the ability to store or communicate electrical energy to a secondary device, or it may be used to recharge a battery in communication with the integrated unit or to provide electrical energy to a remote location. As an alternative configuration, the generating unit may be in the form of any device that generates energy from rotation, including, but not limited to an air compressor, a hydraulic pump, a motor, a water pump, heat friction, etc.

The power plant(s) illustrated herein may be employed in various environments where they may create their own fluid flow. For example, the power plant may be housed in an enclosure such as a building or garage, or any locale that is sized to accommodate the power plant. The elements described above may be useful for any application wherein a fluid force exerted on a fluid responsive generator unit can be utilized to rotate the rotational element. Fluid flow may come in the form of air flow, water flow, or an alternative fluid source that supports rotation of the rotational elements. In one embodiment, the power generated by the generator is stored in a battery or a bank of batteries and used to power a local or remote motor in communication with the battery. Similarly, in one embodiment, the generated electrical energy may be communicated directly from the generator unit to an external motor or device requiring energy an input power source, or to a power grid providing energy to external energy consumers or consuming equipment. In addition, the vertical members and horizontal arms of the power plant should not be restricted to the angles disclosed herein. Rather, they may be at any angle that would enable rotation of the generator units to create a fluid flow and to convert the fluid flow to electrical energy. Accordingly, the scope of protection of this invention is limited only by the claims and their equivalents.

I claim:

1. An apparatus comprising:
a support member having a proximal end and a distal end;
a first rotatable element attached to said distal end of said support member, and said first rotatable element rotatable about an axis of said support member;
a tether system having a distal end and a proximal end, the distal end of the tether system in communication with the first rotatable element, the proximal end of the tether system in communication with an energy generating unit, the unit comprising:
a second rotatable element with at least one blade, with the at least one blade in communication with a first shaft;
a generator in communication with a second shaft, wherein the first shaft communicates rotational movement to the second shaft;
said energy generating unit to generate energy by exposure of said at least one blade of the second rotatable element to a fluid flow and communication of the rotation of the at least one blade from the first shaft to the second shaft.

2. The apparatus of claim 1, further comprising a rotational device in communication with the first rotatable element, the rotational device to initiate and maintain rotational movement of the first rotatable element, wherein the rotational movement creates the fluid flow to rotate the blades of the second rotatable element.

3. The apparatus of claim 1, wherein the tether system includes at least one tether in electrical communication with a secondary support element, wherein each tether and the secondary support element are configured to incorporate at least one energy transfer device.

4. The apparatus of claim 1, wherein a vertical section of the secondary support element is in communication with the energy generating device.

5. The apparatus of claim 1, wherein said generated energy is communicated to an energy storage element through the tether system.

6. The apparatus of claim 3, further comprising a distal end of each tether attached to the first rotatable element and a proximal end of each tether attached to a planar section of the secondary support element.

7. The apparatus of claim 1, wherein said second rotatable element communicates with the energy generating unit via communication means selected from the group consisting of: a gear box, a drive belt, a system of pulleys, a direct drive system, gears, and a hydraulic system.

8. The apparatus of claim 3, further comprising the tether system including two tethers in communication with the single secondary support element, the distal end of a first tether received at a first location of the first rotatable element and a distal end of a second tether received at a second location of the first rotatable element.

9. The apparatus of claim 8, further comprising the first tether received at a first end of the planar section of the single secondary support element and the second tether received to at a second end of the planar section of the single secondary support element, wherein the first and second end of the planar section of the single secondary support element are different locations.

10. An apparatus comprising:
a support member having a proximal end and a distal end;
a first rotatable element attached to said distal end of said support member, and said first rotatable element rotatable about an axis of said support member;
a tether system including at least one tether in communication with a secondary support element, wherein a distal end of the tether is attached to the first rotatable element and a proximal end of the tether is attached to the secondary support element;
a generating unit in communication with the secondary support element, said generating unit including a second rotatable element having at least two blades and a generator; and
the generating unit having a generator in communication with the second rotatable element to generate energy, wherein said blades of the second rotatable element are exposed to a fluid flow and communicate rotation to a shaft in communication with the generator.

11. The apparatus of claim 14, wherein each tether and the secondary support element are configured to incorporate at least one energy transfer device.

12. The apparatus of claim 10, wherein the tether system includes four tethers, a first and a second tether received at a first location of the first rotatable element and a third and a fourth tether received at a second location of the first rotatable element.

13. The apparatus of claim 12, wherein the first and third tethers are attached to the left end of the planar section of the secondary support element and the second and the fourth tethers are attached to the right end of the planar section of the secondary support element.

14. The apparatus of claim 10, wherein said second rotatable element communicates with the generator via communication means selected from the group consisting of: a gear box, a drive belt, a system of pulleys, a direct drive system, gears, and a hydraulic system.

15. The apparatus of claim 10, further comprising at least two generators in communication with the second rotatable element to separately generate energy responsive to rotational movement of the second rotatable element.
